(19) United States
(12) Patent Application Publication
(10) Pub. No.: US 2013/0025511 A1
(43) Pub. Date: Jan. 31, 2013

(54) HANDGUN SAFE

(71) Applicant: Timothy Eugene Maxwell, North Olmsted, OH (US)

(72) Inventor: Timothy Eugene Maxwell, North Olmsted, OH (US)

(21) Appl. No.: 13/558,077

(22) Filed: Jul. 25, 2012

Related U.S. Application Data
(60) Provisional application No. 61/511,178, filed on Jul. 25, 2011.

(51) Int. Cl. E05G 1/04

(52) U.S. Cl. 109/59 R

(57) ABSTRACT

A safe (10) comprising a housing (20) defining a storage chamber (21), a door (40) moveable between closed and opened positions, a locking mechanism (50) convertible between locked and unlocked conditions, and biometric identifier (60) which senses biometric features to identify a person attempting to access the storage chamber (21). A microprocessor (70) causes conversion of the locking mechanism (50) from its locked condition to its unlocked condition upon identification by the biometric identifier (60) of authorized use. The safe (10) can be used, for example, to store a handgun.

### RELATED APPLICATION

This application claims priority under 35 USC. §119(e) to U.S. Provisional Patent Application No. 61/511,178 filed on Jul. 25, 2011. The entire disclosure of this provisional application is hereby incorporated by reference.

### BACKGROUND

Law enforcement personnel are part of every culture in our world and many of them carry handguns in the performance of their duties. In many organizations, each individual law enforcement officer is issued a firearm for which he/she is accountable both on and off duty. When the officer returns home after work, protocol usually requires that the gun be locked in a safe to prevent theft by criminals and/or contact by children.

### SUMMARY

A handgun safe is provided which is especially suited for use in a home setting and/or for law-enforcement gun storage during off-duty hours. The safe can be opened only upon confirmation of biometric parameters of an authorized person.

### DRAWINGS

FIGS. 1-2 show the handgun safe in a closed condition and in an open condition, respectively.

FIG. 3 shows the handgun safe with its door being invisible so as to reveal the locking mechanism.

FIG. 4 shows electronic components of the handgun safe.

### DESCRIPTION

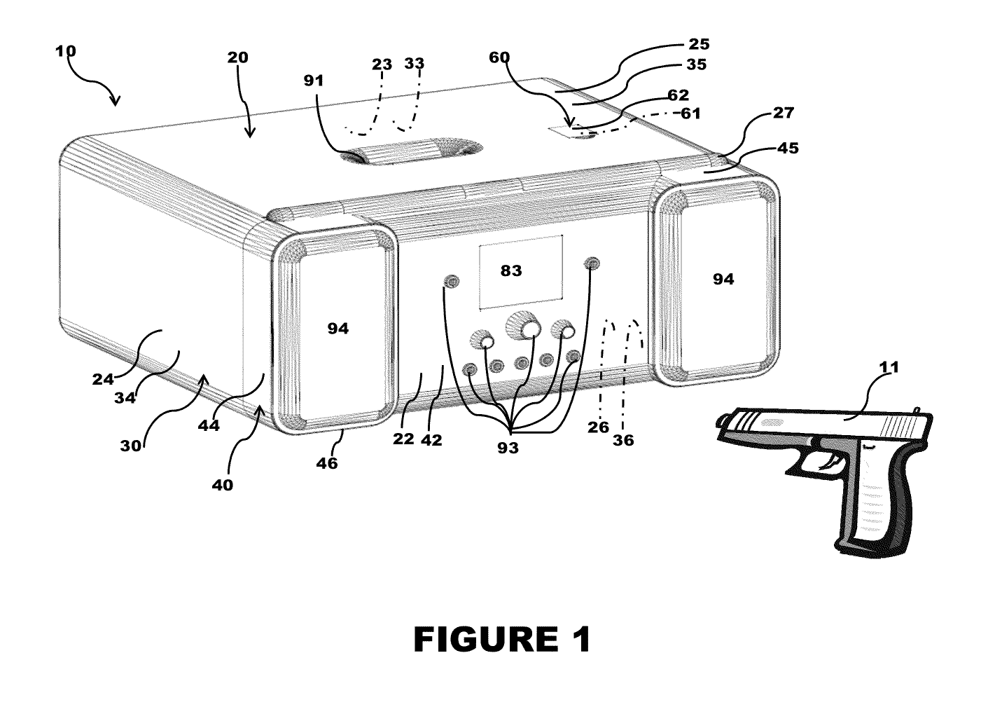

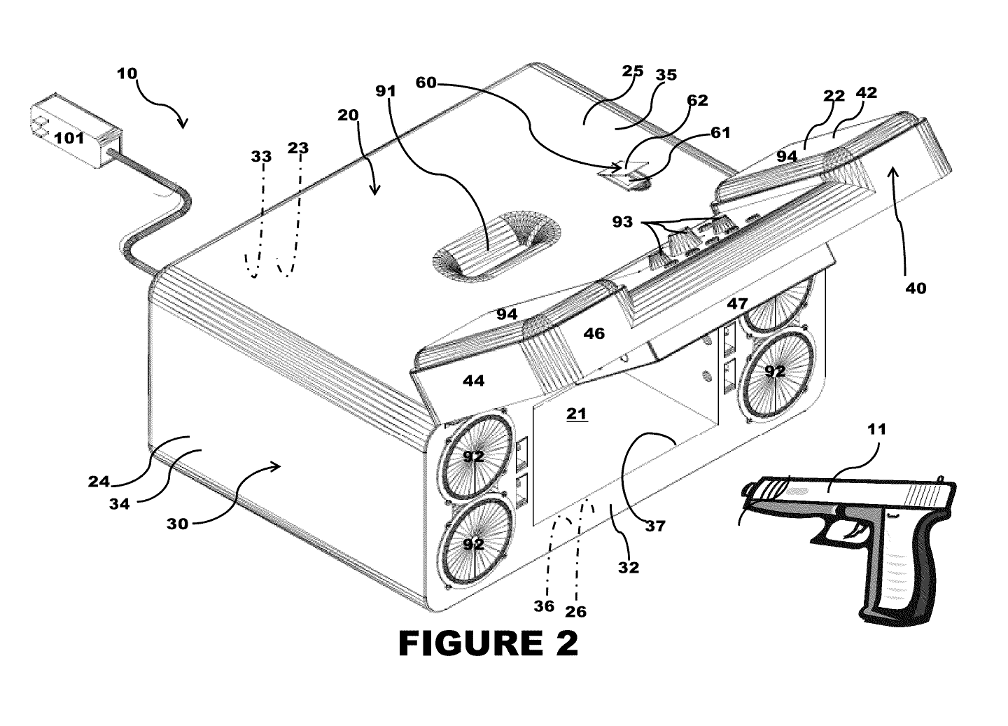

Referring now to the drawings, and initially to FIGS. 1 and 2, a handgun safe 10 is shown which can be used to store a handgun 11 in a home setting. The safe 10 comprises a housing 20 defining a gun-storage chamber 21 sized to receive the handgun 11. When the safe 10 is closed (FIG. 1), the walls 22-26 of the housing 20 define a strong and secure envelope around the gun-storage chamber 21. The housing walls 22-26 can be relatively thick and/or comprise steel bars disposed within concrete. In any event, the housing 20 is constructed so at to prevent access to the gun-storage chamber 21 by breaking through its walls 22-26.

The housing 20 is preferably self-standing, that it is the housing 20 is not part of another piece of furniture or building structure. In this manner, the handgun safe 10 can be placed on a dresser, table, shelf or other convenient surface on a home setting. Additionally or alternatively, the housing 20 is compactly sized so as to not monopolize space in a bedroom or other domestic locale. The housing 20 can be, for example, less than twenty inches long, less than twenty inches wide, and less than ten inches tall.

The housing 20 can comprise a cabinet 30 and a door 40. The door 40 is movable between a closed position (FIG. 1) whereat access to the gun-storage chamber 21 is prevented and an opened position (FIG. 2) whereat access to the gun-storage chamber 21 is allowed. Thus, to introduce the handgun 11 to the storage chamber 21 or remove it therefrom, the door 40 is moved to its opened position. The housing 21 can include a hinge 22, or other means, for movably mounting the door 40 on the cabinet 30.

The illustrated cabinet 30 comprises a front wall 32, a rear wall 33, side walls 34, a top wall 35, and a bottom wall 36. The illustrated door 40 comprises a front face 42, a rear face 43, side edges 44, a top edge 45, and a bottom edge 46. The cabinet's walls 33-36 form the corresponding walls 23-26 of the housing 20, and the door 40 forms the front wall 22 of the housing 20. The hinge 27 extends between the cabinet's top wall 35 and the door's top edge 45 whereby the door 40 pivots upward and downward when moving between the closed and opened positions.

The cabinet 30 includes a window 37 which communicates with the gun-storage chamber 21. The door 40 includes an inset 47 which fits inside window 37 when the door 40 is in the closed position.

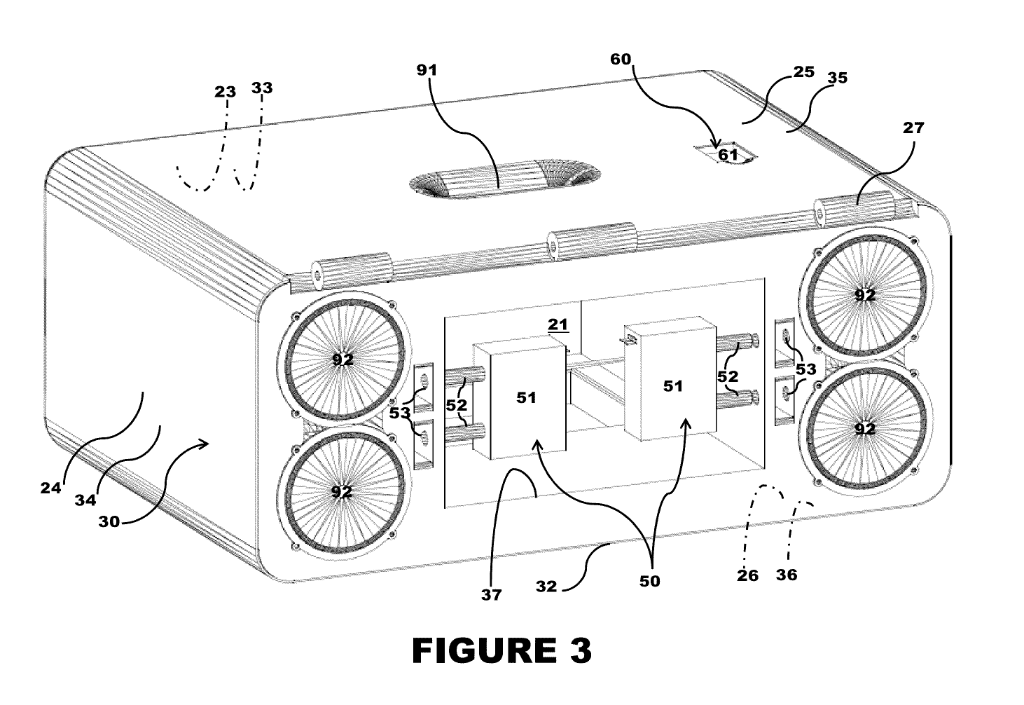

As is best seen by referring additionally to FIG. 3, the handgun safe 10 comprises a locking mechanism 50 which is convertible between a locked condition and an unlocked condition. In the locked condition, the door 40 is locked in its closed position. In the unlocked condition, the door is unlocked for selective movement between its closed position and its opened position.

The illustrated locking mechanism 50 comprises two locking devices 51 contained within the inset 47 in the door 40. In the illustrated embodiment, each locking device 51 includes two deadbolts 52 which shift between an extended stance and retracted stance to convert the locking mechanism between its locked condition and its unlocked condition. In the extended stance, the deadbolts 52 protrude laterally outward from the door inset 47 and into aligned cylindrical receipts 53 in the front wall 32 of the cabinet 30.

The locking mechanism 50 and/or the locking devices 51 are electronically activated to move from the locked condition to the opened condition. The locking device 51 can comprise, for example, solenoid structures having plungers operably coupled to the deadbolts 52. The deadbolts 52 can remain in the extended stance in the absence of electrical activation and shift to the retracted stance upon electrical activation. In this manner, the safe 10 will remain locked in the event of a power outage.

The handgun safe 10 comprises a biometric identifier 60 which allows only a pre-enrolled person to convert the locking mechanism 50 from its locked condition to its unlocked condition. The identifier 60 includes a biometric sensor 61 which, in the illustrated embodiment, resides on the top wall 25 of the housing 20 (i.e., also the top wall 35 of the cabinet 30) and is adapted to sense a person's fingerprint. A liftable lid 62 can cover the sensor 61 and camouflage it when the identifier 60 is not in use.

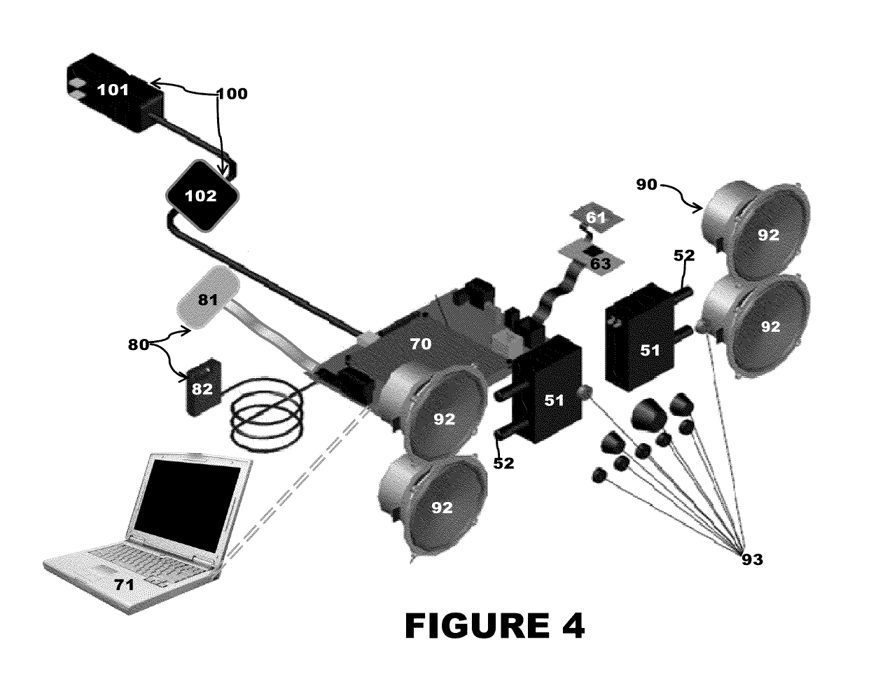

As is best seen by referring additionally to FIG. 4, the handgun safe 10 comprises a microprocessor 70 which coordinates with the biometric identifier 60 to operate the locking mechanism 50. Specifically, for example, the microprocessor 70 receives input from the biometric sensor 61 and its interpreter 63 verifying that an enrolled person wishes to open the handgun safe 10. The microprocessor 70 then electrically activates the locking devices 51 so as to shift the deadbolts 52 from their extended stance to their retracted stance. The door 40 is then pivoted upwardly to allow access to the gun-storage chamber 21.

Enrollment of a person as an authorized user of the handgun safe 10 can be accomplished by one or more designated enrollment managers. Such a manager can be appointed, for example, by the law enforcement organization issuing firearms to personnel. The microprocessor 70 can be pre-programmed with the relevant biometrics of the managers so as to allow them (and only them) the ability to enroll a person with the right to open the safe 10.

When a specific handgun safe 10 has been assigned to a particular person, the manager inputs his/her biometrics into the sensor 61, and initiates the enrollment progress via typing a code into the keypad 71, and introduces the enrollee's biometrics via the sensor 61. Thereafter, only this enrollee will be able to actuate opening of the handgun safe 10.

The keypad 71 (or other programming equipment) can be integrally formed with the handgun safe 10, such as in its housing 20. However, as shown, the keyboard 71 can be part of a personal computer connected to the microprocessor 70 to perform the enrollment progress.

The handgun safe 10 can include an activity monitor 80 which works in conjunction with the microprocessor 70 to monitor activity. Upon insertion of the handgun 11 into the storage chamber 21, a reader 81 can recognize this particular gun per a unique tag thereon and convey this information to the microprocessor 70. The reader 81 and the gun tag can be, for example, an RFID reader and an RFID tag.

The microprocessor 70 can confirm (e.g., with proximity switches) that the door 40 has been moved to its closed position and the locking mechanism has been converted to its locked condition. A data package is created containing the identity of the person opening the safe 10, the recognition of the gun 11, the closing of the safe 10, and time stamps for these events. This data package can be conveyed via wireless module 82 to a remote supervisory station. Some or all of this data can be displayed on a screen 83 situated, for example, on the door 40 (i.e., the front wall 22 of the housing 20).

The handgun safe 10 can comprise a music system 90 including, for example, a docking station 91 for a personal music storage device, speakers 92, and control dials 93. In the illustrated embodiment, the docking station 91 is built into the top wall 35 of the cabinet 30 (i.e., top wall 25 of the housing 20), the speakers 92 are built into the side walls 34 of the cabinet 30 (i.e., the side walls 24 of the housing 20), and control dials 93 are built into the door 40 (i.e., the front wall 22 of the housing 20). The door 40 can further include speaker-compatible compartments 94 aligned with the speakers 92 when in its closed position.

The incorporation of a music system 90 into the safe 10 not only doubles its utility, but also disguises the seriousness of its primary purpose. Depending upon other aesthetics, the safe 10 could be overlooked as a gun-guarding receptacle by unfamiliar eyes.

The locking mechanism 50, the biometric identifier 60, the microprocessor 70, the activity monitor 80, and the music system 90 can be supplied with electrical power via power supply 100. The power supply 100 can include, as illustrated, a plug 101 for a standard 120 vac outlet found in most homes. Battery backup 102 can also be provided to accommodate power outages.

In a residential setting, for example, where a citizen wants to store his or her handgun, the safe 10 can be shipped with the door 40 ajar. Once power is applied (e.g., via a battery or wall outlet), an administrative button can be pushed to begin authorization enrollment. This button can be located, for example, inside the cabinet 30 and/or within the storage chamber 21. A signal can then be sent that swiping of fingerprint features (e.g., thumbprint features) can begin on the biometric identifier 60. A plurality of “good swipes” can be required for enrollment, with signals verifying swipe sufficiency. The signals can comprise, for example, lights (e.g., leds) which shine green for good, red for bad, yellow for issues, etc.

Once the person's fingerprint features are accepted, he or she is authorized to open the safe 10. If the authorized person swipes the biometric identifier a signal can be provided and the locking mechanism 50 converted to its open condition by the microprocessor. If a nonauthorized person swipes the biometric identifier, a “no access” signal can be provided and the locking mechanism can remain in its closed condition.

If the safe 10 is registered with the manufacturer or other monitoring entity, an alert (e.g., email or text) will be sent to the customer if and when a new authorized person is added.

The safe 10 can include additional and/or alternative alerts, to indicate tampering, no power, heartbeats etc. Courtesy reminders, regarding safe-opening times, can be provided, which may have special applicability when the safe 10 is used to store pharmaceutical products which should be administered during certain time frames.

One may now appreciate that a handgun safe 10 is provided with is especially suited for use in a home setting and/or can effectively monitored at a remote supervisory site. Although the safe 10, the housing 20, the cabinet 30, the door 40, the locking mechanism 50, the biometric identifier 60, the microprocessor 70, the activity monitor 80, the music system 90, and/or the power supply 100 have been shown and described with respect to a certain embodiment or embodiments, equivalent alterations and modifications will occur to others skilled in the art upon review of this specification and the annexed drawings. For example, the safe 10 can be used to store sensitive items other than guns, such as pharmaceutical products.

### REFERENCE NUMBERS

10=gun safe
20=housing
21=gun-storage chamber
22=housing front wall
23=housing rear wall
24=housing side walls
25=housing top wall
26=housing bottom wall
27=cabinet-door hinge
30=cabinet
32=cabinet front wall
33=cabinet rear wall
34=cabinet side walls
35=cabinet top wall
36=cabinet bottom wall
37=window
40=door
42=door front wall
43=door rear wall
44=door side edges
45=door top edge
46=door bottom edge
47=window inset
50=locking mechanism
51=locking units
52=deadbolts
53=cylindrical receipts
60=biometric identifier
61=sensor
62=lid
63=interpreter
70=microprocessor controller
71=keypad
80=monitoring system
81=reader
82=wireless module
90=music system
91=docking station
92=speakers
93=dials
94=speaker compartments
100=power supply
101=120 vac
102=battery backup

1. A safe comprising:
a housing defining a chamber and including a door movable between an open position allowing access to the storage chamber and a closed position preventing access to the storage chamber;
a locking mechanism convertible between a locked condition whereat the door is locked in its closed position and an unlocked condition whereat the door is unlocked for selective movement between its closed position and its open position;
a biometric identifier which senses biometric features to identify a person attempting to access the storage chamber;
a microprocessor which causes conversion of the locking mechanism from its locked condition to its unlocked condition upon identification by the biometric identifier of an authorized person.

2. A safe as set forth in claim 1, wherein the housing is self-standing.

3. A safe as set forth in claim 2, placed on a dresser or table top.

4. A safe as set forth in claim 1, wherein the housing is less than twenty inches long, less than twenty inches wide, and less than ten inches tall.

5. A safe as set forth in claim 1, wherein the housing comprises a cabinet to which the door is movably mounted.

6. A safe as set forth in claim 5, wherein the cabinet includes a window which communicates with the storage chamber, wherein the door shuts this window when in its closed position.

7. A safe as set forth in claim 1, wherein the locking mechanism comprises at least one locking device including a deadbolt which shifts between an extended stance and retracted stance to convert the locking mechanism between its locked condition and its unlocked condition.

8. A safe as set forth in claim 7, wherein each locking devices is electronically activated to convert the locking mechanism from its locked condition to its opened condition.

9. A safe as set forth in claim 8, wherein each deadbolt remains in its extended stance in the absence of electrical activation and shifts to its retracted stance upon electrical activation.

10. A safe as set forth in claim 1, wherein the biometric identifier includes a biometric sensor residing on the housing.

11. A safe as set forth in claim 10, wherein the biometric sensor is adapted to sense the features of a person's fingertip.

12. A safe as set forth in claim 11, wherein the biometric sensor is adapted to sense the features of a person's thumbprint.

13. A safe as set forth in claim 11, wherein the biometric sensor resides on the top wall of the housing.

14. A safe as set forth in claim 1, wherein the housing is self-standing for placement on a dresser or table top, wherein the housing is less than twenty inches long, less than twenty inches wide, and less than ten inches tall, and wherein the biometric identifier includes a biometric sensor residing on the housing

15. A safe as set forth in claim 14, wherein the housing comprises a cabinet to which the door is movably mounted, wherein this cabinet includes a window which communicates with the storage chamber, and wherein the door shuts this window when in its closed position.

16. A safe as set forth in claim 15, wherein the locking mechanism comprises at least one locking device including a deadbolt which shifts between an extended stance and retracted stance to convert the locking mechanism between its locked condition and its unlocked condition;
wherein each locking devices is electronically activated to convert the locking mechanism from its locked condition to its opened condition; and
wherein each deadbolt remains in its extended stance in the absence of electrical activation and shifts to its retracted stance upon electrical activation.

17. A safe as set forth in claim 1, wherein the storage chamber is sized to receive pharmaceutical products.

18. A safe as set forth in claim 17, and pharmaceutical products within the storage chamber.

19. A handgun safe comprising:
a housing defining a gun-storage chamber sized to receive a handgun and including a door movable between an open position allowing access to the gun-storage chamber and a closed position preventing access to the gun-storage chamber;
a locking mechanism convertible between a locked condition whereat the door is locked in its closed position and an unlocked condition whereat the door is unlocked for selective movement between its closed position and its open position;
a biometric identifier which senses biometric features to identify a person attempting to access the gun-storage chamber;
a microprocessor which causes conversion of the locking mechanism from its locked condition to its unlocked condition upon identification by the biometric identifier of an authorized person.

20. A handgun safe as set forth in claim 19, and a gun within the gun-storage chamber.
